(19) United States
(12) Patent Application Publication
(10) Pub. No.: US 2025/0004923 A1
(43) Pub. Date: Jan. 2, 2025

(54) MAPPING OF TESTS FOR A SPECIFICATION OF SAFETY RELATED APIs

(71) Applicant: Red Hat, Inc., Raleigh, NC (US)

(72) Inventors: Rachel Elizabeth Sibley, Raleigh, NC (US); Pablo Antonio Martin, Madrid (ES); Luigi Pellecchia, Milan (IT)

(21) Appl. No.: 18/545,978

(22) Filed: Dec. 19, 2023

Related U.S. Application Data
(60) Provisional application No. 63/510,533, filed on Jun. 27, 2023.

(51) Int. Cl. G06F 11/36

(52) U.S. Cl. CPC G06F 11/3676

(57) ABSTRACT

A method of identifying, from a specification document of a software system, requirements of the software system related to vehicle safety functions, identifying one or more tests for safety related application programming interfaces, determining, for each of the one or more tests, coverage of source code of the software system, and mapping, by a processing device, each of the one or more tests to requirements of the software system identified from the specification document in view of the coverage of the source code of the software system for each of the one or more tests.

### CROSS-REFERENCE TO RELATED APPLICATIONS

This application claims priority from and the benefit of U.S. Provisional Patent Application No. 63/510,533 filed Jun. 27, 2023, the entire contents of which are incorporated herein by reference.

### TECHNICAL FIELD

Aspects of the present disclosure relate testing of safety related application programming interfaces (APIs), and more particularly, mapping of tests for safety related APIs to a specification of a software system.

### BACKGROUND

Modern vehicles incorporate many different hardware and software components to provide computer systems that manage various different aspects of vehicle operation. Some of the components support or otherwise are related to safety functions of the vehicle. Many other types of hardware and software, such as medical devices, aerospace components, and many more, also include safety functions to maintain safety of people and objects in contact with the system. Such safety functions must be tested and certified with evidence supporting the proper operation of the safety functions.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram that illustrates a component diagram of an illustrative example of a vehicle computer system architecture, in accordance with some embodiments.

FIG. 2A depicts an example of an indirect mapping of tests to portions of a software system specification, according to some embodiments.

FIG. 2B depicts an example of direct mapping of tests to portions of a software system specification, according to embodiments.

FIG. 3 depicts a component diagram of an example system for identifying and mapping test coverage for a specification of software system, according to some embodiments.

FIG. 4 depicts a flow diagram of an example method of identifying and mapping test coverage for a specification of a software system, according to some embodiments.

FIG. 5 depicts a flow diagram of another example method of mapping test coverage for a specification of a software system, according to some embodiments.

FIG. 6 is a block diagram of an example apparatus that may perform one or more of the operations described herein, in accordance with some embodiments of the present disclosure.

### DETAILED DESCRIPTION

Functional safety within the automotive industry requires a high confidence in test coverage for software managed safety function, especially for code paths of the software that may interfere with or support a safety function of a vehicle, or any other computer system which affects the safety of people or objects in contact with the computer system. For example, the software that may affect a safety function of a vehicle may need to be properly tested to ensure that the safety functions of a vehicle will work as expected and not put an occupant of a vehicle, pedestrian, or any other person, or object, coming into contact with vehicle, in danger. In conventional testing, in order to determine that a portion of software or code paths have been tested, manual running and application of available tests to the software has to be performed and tracked. However, such processes are tedious, time intensive, and may not be able to provide evidence of coverage of a software design level, such as a specification.

For application programming interfaces (APIs) within the safety scope, it is imperative to be able to map coverage of applicable software tests or test capabilities against the safety APIs identified in the software or system specification. Currently, coverage for existing tests is not easily traceable to the specification (e.g., manual pages, otherwise referred to as “man pages”) of the software/system where the test case is missing necessary metadata or traceability back to the design specification. Accordingly, the lack of traceability makes evaluation of the completeness of a verification difficult because evidence may be lacking to show how the requirements are tested down to the design level.

Aspects of the disclosure address the above-noted and other deficiencies by providing a process to identify and map existing test coverage against safety related APIs using static and code coverage analysis. Additionally, the mapping of the existing test coverage may be used to identify and reduce gaps in test coverage of safety APIs. In some examples, the process may trace test cases and map them against a specification, such as a man page (also referred to as a manual page), to provide sufficient evidence necessary to comply with required safety standards (e.g., ISO 26262 standards).

In some examples, a list of safety APIs may be defined. For example, the safety APIs may be identified from a standard (e.g., Automotive Safety Integrity Level (ASIL)) indicating which safety related functions are covered within the standard. Processing logic may generate a static analysis report to show available tests in one or more repositories or other data store that the processing logic may access that may be applied against the list of safety APIs. In some examples, the static analysis report may be broken down by confidence level (e.g., indicating the confidence level that the API is covered by the identified test). For examples, confidence level 1 may include tests in which the API may appears in the file path and the API call appears in the test file, indicating that there is a very high probability that the test applies to and covers the corresponding API. In addition to the static analysis report, a code coverage analysis may generate a tailored report, for a particular software system, identifying portions (e.g., code and code paths) of the software system that are executed and covered by the available tests. In some examples, the code coverage analysis may identify all code that is tested and covered by the one or more tests within a confidence level identified by the static analysis report.

After the static analysis report identifying the available tests for safety APIs and the code coverage analysis provides the coverage of the available tests against the software system, processing logic may then compare the coverage of the tests against key lines of source code corresponding to testable requirements identified from a specification document of the software system. The processing logic may then map the tests to the testable requirements of the specification document based on the code coverage of the tests matching (e.g., overlapping) the source code corresponding to the testable requirements. In other words, the processing logic identifies the tests that cover the testable requirements of the specification document by identifying the tests that cover the source code that implements the testable requirements.

In some embodiments, the code coverage analysis may determine a percentage coverage of the tests against one or more of the identified safety related APIs. For example, the code coverage analysis may use a modified gcovr command to show both additional stats related to lines/branches/decisions/calls, including a difference/merge feature to show granularity of API test coverage and related test cases exercising the API. Additionally, the processing logic may identify the test cases related to an API to provide traceability between the specification (e.g., man page) and test cases (e.g., test specification), to understand where gaps in test coverage exist. Although described herein as being applied to safety standards for vehicles, embodiments may also apply to any software testing standards for test coverage to be identified for specification documents. For example, embodiments may also apply to manufacturing line software, cell phone software, medical devices, aerospace software (e.g., airplanes, rockets, projectiles, etc.) or any other software against which testing standards may be applied.

Embodiments of the present disclosure provide advantages over existing technology by providing traceability between a safety API in the specification and related test case and tailored reports identifying code coverage for a fixed set of functions (e.g., a list of ASIL functions which belong to the safety scope). Additionally, embodiments provide for higher confidence in test coverage with respect to safety requirements and accelerates compliance against safety standards to provide evidence related to the completeness of verification of safety requirements. Embodiments may also assist with providing justification for Functional Safety Certification. Furthermore, embodiments may save time with respect to manual inspection of reports and individual files to review if the safety related APIs were exercised or not and may save time and resources by providing an automated and scalable approach which includes both identifying existing coverage along with tracking progress with respect to eliminating gaps in coverage for safety related APIs. Embodiments further help identity whether config files are in place for large test suites (e.g., LTP) where flaky/failing test cases are a factor which helps to highlight any gaps in test coverage.

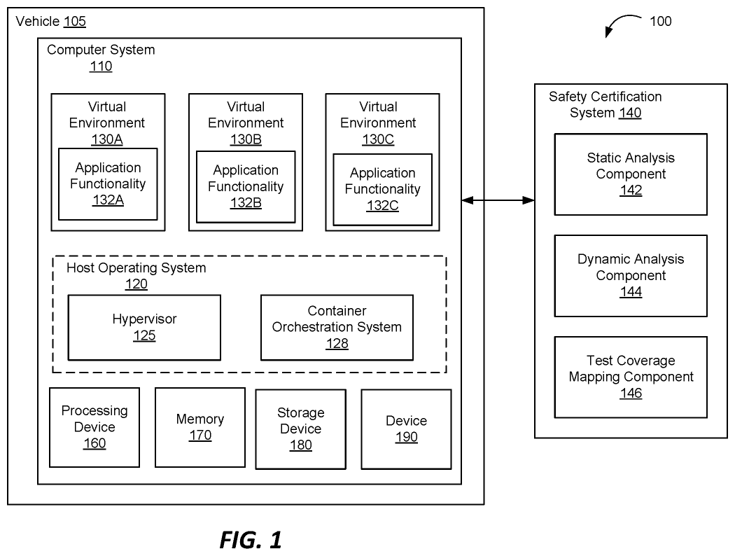

FIG. 1 is depicts a high-level component diagram of an illustrative example of a vehicle computer system architecture 100, in accordance with one or more aspects of the present disclosure. One skilled in the art will appreciate that other computer system architectures are possible, and that the implementation of a computer system utilizing examples of the invention are not necessarily limited to the specific architecture depicted by FIG. 1.

As shown in FIG. 1, vehicle computer system architecture 100 includes a vehicle 105 with a computer system 110 coupled with a safety certification system 140. The computer system 110 includes one or more processing devices 160, memory 170, which may include volatile memory devices (e.g., random access memory (RAM)), non-volatile memory devices (e.g., flash memory) and/or other types of memory devices, a storage device 180 (e.g., one or more magnetic hard disk drives, a Peripheral Component Interconnect [PCI] solid state drive, a Redundant Array of Independent Disks [RAID] system, a network attached storage [NAS] array, etc.), and one or more devices 190 (e.g., a Peripheral Component Interconnect [PCI] device, network interface controller (NIC), a video card, an I/O device, etc.). In certain implementations, memory 170 may be non-uniform access (NUMA), such that memory access time depends on the memory location relative to processing devices 160. It should be noted that although, for simplicity, computing system 110 is depicted as including a single processing device 160, storage device 180, and device 190 in FIG. 1, other embodiments of computer system 110 may include a plurality of processing devices, storage devices, and devices. Similarly, safety certification system may include a plurality of processing devices, storage devices, and devices. The computer system 110 and safety certification system 140 may each be an edge computing device or system deployed to a vehicle, a server, a mainframe, a workstation, a personal computer (PC), a mobile phone, a palm-sized computing device, etc. In embodiments, computer system 110 and safety certification system 140 may be separate computing devices. In some embodiments, computer system 110 and safety certification system 140 may be implemented by a single computing device. For clarity, some components of safety certification system 140 and computer system 110 are not shown. Furthermore, although computer system architecture 100 is illustrated as having one computer system 110, embodiments of the disclosure may utilize any number of coupled computer systems.

Computer system 110 may additionally include one or more virtual environments 130A-C (e.g., virtual machines (VMs), containers, or other sandbox environments), and host operating system (OS) 120. A VM may be a software implementation of a machine that executes programs as though it were an actual physical machine. A container may act as an isolated execution environment for different functions of applications. The virtual environments 130A-C may each be an instance of a serverless application or function for executing one or more applications of a serverless framework. Host OS 120 manages the hardware resources of the computer system and provides functions such as inter-process communication, scheduling, memory management, and so forth.

Host OS 120 may include a hypervisor 125 (which may also be known as a virtual machine monitor (VMM)), which provides a virtual operating platform for VMs 130 and manages their execution. Hypervisor 125 may manage system resources, including access to physical processing devices (e.g., processors, CPUs, etc.), physical memory (e.g., RAM), storage device (e.g., HDDs, SSDs), and/or other devices (e.g., sound cards, video cards, etc.). The hypervisor 125, though typically implemented in software, may emulate and export a bare machine interface to higher level software in the form of virtual processors and guest memory. Higher level software may comprise a standard or real-time OS, may be a highly stripped down operating environment with limited operating system functionality, and/or may not include traditional OS facilities, etc. Hypervisor 125 may present other software (i.e., “guest” software) the abstraction of one or more VMs that provide the same or different abstractions to various guest software (e.g., guest operating system, guest applications). It should be noted that in some alternative implementations, hypervisor 125 may be external to host OS 120, rather than embedded within host OS 120, or may replace host OS 120. Host OS 120 may include, either in addition to or alternative to the hypervisor 125, a container orchestration system 128 to deploy and manage containers in the computer system for executing one or more aspects of a application functionality 132A-C.

The computer system 110 may be coupled with the safety certification system 140 (e.g., may be operatively coupled, communicatively coupled, may communicate data/messages with each other) via a network. The network may be a public network (e.g., the internet), a private network (e.g., a local area network (LAN) or wide area network (WAN)), or a combination thereof. In one embodiment, the network may include a wired or a wireless infrastructure, which may be provided by one or more wireless communications systems, such as a WiFi™ hotspot connected with the network and/or a wireless carrier system that can be implemented using various data processing equipment, communication towers (e.g., cell towers), etc. The network may carry communications (e.g., data, message, packets, frames, etc.) between the various components of computer system 110 and/or safety certification system 140.

In embodiments, the safety certification system 140 may execute a static analysis component 142, a dynamic analysis component 144, and a test coverage mapping component 146. The static analysis component 142 may scan available test repositories for tests that correspond a safety related API. In some embodiments, the static analysis component 142 may identify the available tests for testing safety related APIs. For example, the static analysis component 142 may identify available tests from one or more repositories, data stores, etc. that apply to a safety related API, such as ASIL APIs related to safety functions of a vehicle, such as an automobile. A vehicle may include an automobile, airplane, boat, ship, train, truck, or any other passenger or freight carrying vehicle which may incorporate software which manages or affects safety functions of the vehicle. In addition, the static analysis component 142 may group the identified tests into confidence levels indicating a likelihood that a test is applicable to a particular API.

The dynamic analysis component 144 may run a code coverage analysis against the tests identified from the available tests for the API. In some examples, the dynamic analysis component 144 may determine which lines of code (e.g., code paths) of a software system are executed and tested by each of the available tests. For example, the dynamic analysis component 144 may execute a test on the software system and identify the code that was executed (e.g., tested) during performance of the test. In some examples, the dynamic analysis component may perform a modified gcovr command, or other code coverage utility or command, to identify the code coverage during performance of the test. Accordingly, the dynamic analysis component 144 may provide an indication of the code coverage for each available test identified by the static analysis component 112.

Test coverage mapping components 146 may generate a coverage map of the available tests to requirements of the software system indicated by documentation (e.g., man page) of the software system. In some examples, the test coverage mapping component 146 may identify testable requirements provided in a specification or documentation of the software system. The test coverage mapping component 146 may further identify the portions of source code to which the testable requirements correspond (e.g., the implementation of the testable requirements in the source code). Additionally, the test coverage mapping component 146 may compare the portions of source code corresponding to the testable requirements to the code coverage identified for each of the available tests by the dynamic analysis component 144. The test coverage mapping component 146 may then identify the tests that cover the source code for the testable requirements and generate a mapping between the tests and the testable requirements. Further details regarding safety certification system 140 will be discussed below.

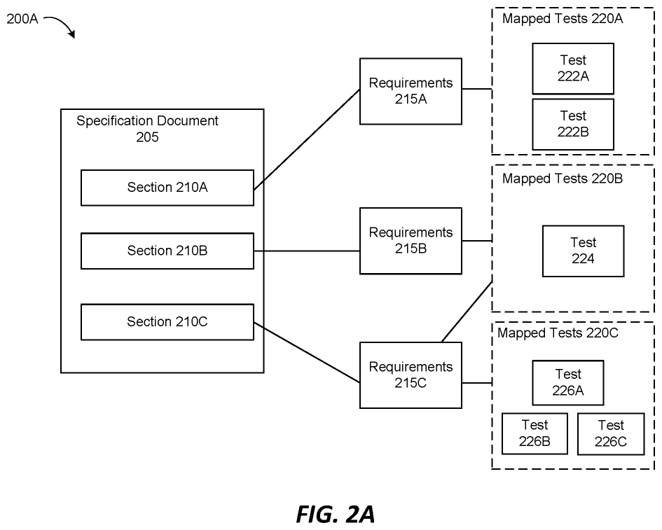

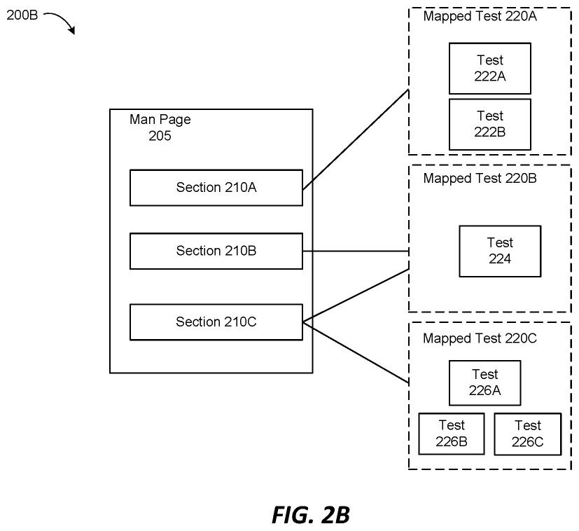

FIG. 2A depicts an example of an indirect mapping 200A of tests to portions of a software system specification, according to some embodiments. As depicted, a specification document 205, such as a manual page (otherwise referred to as a man page), may include one or more sections 210A-C describing various aspects of a software system. For example, the specification document 205 may include a first section 210A describing a first functionality and/or requirements that the software system is to perform or satisfy, a second section 210B describing a second functionality and/or requirement of the software system, and a section 210C describing a third functionality or requirement of the software system. In some examples, a safety certification system (e.g., safety certification system 140) may identify the described requirements 215A-C from the various sections 210A-C of the specification document 205 and map the sections 210A to the corresponding requirements 215A-C. As described herein, the safety certification system may further identify the code coverage of each available test for various safety related APIs against the code of the software system. Accordingly, the safety certification system may further map the identified requirements 215A-C to the tests that cover the source code corresponding to those requirements 215A-C. For example, test 222A and 222B of mapped tests 220A may be identified as covering the source code associated with the requirements 215A and described by section 210A of the specification document 205. Similarly, test 224 of mapped tests 220B may be identified as covering the source code associated with at least the requirements 215B and described by section 210B of the specification documents and tests 226A-C of mapped tests 220C may be identified as covering the source code associated with the requirements 215C and described by section 210C of the specification document 205. Additionally, some tests may cover multiple requirements and some requirements may be covered by multiple tests. For example, as depicted, test 224 may cover both requirements 215B and requirements 215C. Furthermore, while FIG. 2A depicts three sections 210A-C and corresponding requirements 215A-C, in various embodiments any number of sections and requirements may be identified within a specification document and multiple specification documents may be processed.

FIG. 2B depicts an example of direct mapping 200B of tests to portions of a software system specification, according to embodiments. Similar to FIG. 2A, a specification document 205 may include various sections (e.g., sections 210A-C) describing requirements of a software system. As described herein, a safety certification system (e.g., safety certification system 140) may identify the code coverage of each available test for various safety related APIs against the code of the software system. Accordingly, the safety certification system may further map the sections 210A-C of the specification document 205 to the tests that cover the source code corresponding to those sections 210A-C. For example, test 222A and 222B of mapped tests 220A may be identified as covering the source code associated with section 210A of the specification document 205. Similarly, test 224 of mapped tests 220B may be identified as covering the source code associated with at least section 210B of the specification documents and tests 226A-C of mapped tests 220C may be identified as covering the source code associated with section 210C of the specification document 205. Additionally, some tests may cover multiple requirements and some requirements may be covered by multiple tests. For example, as depicted, test 224 may cover both sections 210B and 210C. Furthermore, while FIG. 2A depicts three sections 210A-C, in various embodiments any number of sections and requirements may be identified within a specification document and multiple specification documents may be processed.

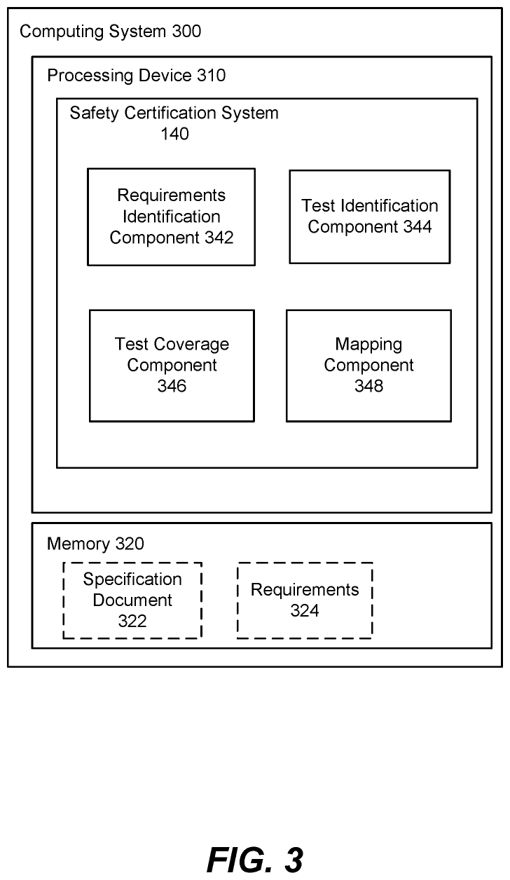

FIG. 3 is a block diagram that illustrates a computing system 300 for download optimization in a mesh network, according to some embodiments. Computing system 300 may include a processing device 310 and memory 330. Memory 330 may include volatile memory devices (e.g., random access memory (RAM)), non-volatile memory devices (e.g., flash memory) and/or other types of memory devices. Processing device 310 may be a central processing unit (CPU) or other processing device of computing system 300. Computing system 300 may be coupled to a mesh network 350. The mesh network 350 may include several computing nodes in communication with one another.

In one example, the processing device 310 may execute a safety certification system 140 for mapping available software tests to testable requirements of a specification document for a software system. The safety certification system may include a requirements identification component 342, a test identification component 344, a test coverage component 346, and a mapping component 348. In some embodiments, the requirements identification component 342 may identify testable requirements (e.g., requirements 324 in memory 320) of a software system that relate to a safety function (e.g., of a vehicle operation, medical device, aerospace software, and so forth). For example, the requirements identification component 342 may parse one or more specification documents (e.g., specification document 322 in memory 320) of a software system to identify portions of the specification document that both describes a requirement 324 of the software system and that relates to a safety function. In some embodiments, the requirements identification component 342, or other component, may further identify key lines of source code of the software system that correspond to each of the identified requirements (e.g., source code that implements the requirements).

In some examples, the test identification component 344 may search repositories for software tests related to safety APIs. For example, the test identification component 344 may search repositories for tests that are available to test safety related APIs (e.g., APIs of an ASIL application which provide a standard for safety functions associated with operation of a vehicle). A vehicle may include an automobile, airplane, boat, ship, train, truck, or any other passenger or freight carrying vehicle which may incorporate software which manages or affects safety functions of the vehicle. In addition, the test identification component 344 may identify various groups or levels of confidence for available tests based on the confidence that the test applies to a safety related API. For example, a first confidence level may indicate a high likelihood that the test applies to a particular safety related API and each subsequent level may provide a lesser confidence. In some examples, the test coverage component 346 may determine the portions of source code of the software system that are executed during performance of each of the tests identified by the test identification component 344. For example, the test coverage component 346 may perform a code coverage utility that track each line and branch of code performed during a test and therefore may provide an indication of the portions of source code covered by each of the identified tests.

In some embodiments, the mapping component 348 may compare the key lines of code corresponding to the testable requirements of the specification documents against the code coverage determined by the test coverage component 346 for each of the tests. Thus, the mapping component 348 may identify which tests cover the source code of the testable requirements 324 by identifying the key lines of source code of a testable requirement covered by a test (e.g., executed during performance of the test). The mapping component 348 may additionally provide an indication of which safety related requirements of the specification document are not covered by any of the available tests to allow further identification and development of tests in areas not yet covered.

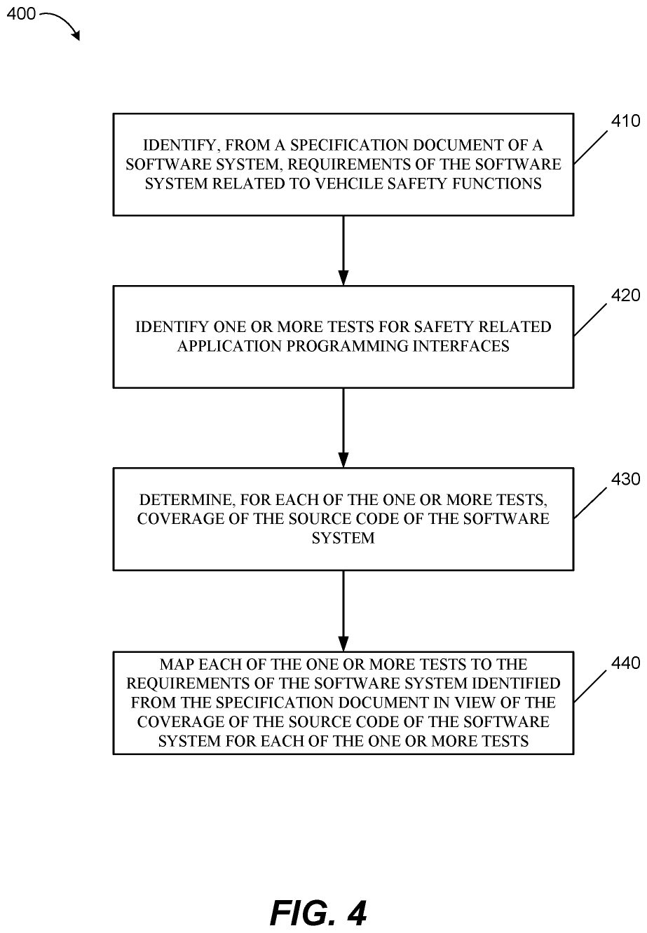

FIG. 4 is a flow diagram of a method 400 of mapping of available software tests to requirements for a specification of a software system, in accordance with one or more aspects of the disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by safety certification system 140 of at least FIG. 1 and/or FIG. 3.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where processing logic identifies, from a specification document of a software system, requirements of the software system related to vehicle safety functions. In some examples, the software system comprises a vehicle integrated software system.

At block 420, processing logic identifies one or more tests for safety related APIs. In some examples, the safety related APIs comprise ASIL safety related APIs associated with vehicle safety standards. In some examples, the processing logic may group the one or more tests for safety related APIs into a multiple confidence levels and iterate through the confidence levels to map the tests in each confidence level to requirements of the specification document.

At block 430, processing logic determines, for each of the one or more tests, coverage of the source code of the software system. In some examples, determining coverage of the source code from each of the one or more tests includes executing a code coverage utility for each of the one or more tests identifying the code paths of the source code executed during each of the one or more tests.

At block 440, processing logic maps each of the one or more tests to the requirements of the software system identified from the specification document in view of the coverage of the source code for each of the one or more tests. In some embodiments, the processing logic identifies key lines of source code corresponding to each requirement of the specification document and compares the source code corresponding to each requirement of the specification document to the coverage of the source code for each of the one or more tests. In some examples, different complexities and variations of logical operators and combinations of lines of code may be used to determine coverage. For example, the processing logic may determine if combinations of lines of code are covered or not using any number and combination of logic operators such as “AND,” “OR,” “XOR,” “NOT,” and any other operator (e.g.: (fileX:line3 AND (fileY:line5 AND fileY:line6)) OR (fileJ:line20 AND NOT fileK:line56). In some examples, the processing logic may identify requirements of the specification document not covered by the one or more tests providing a recommendation or indication of the requirements not covered.

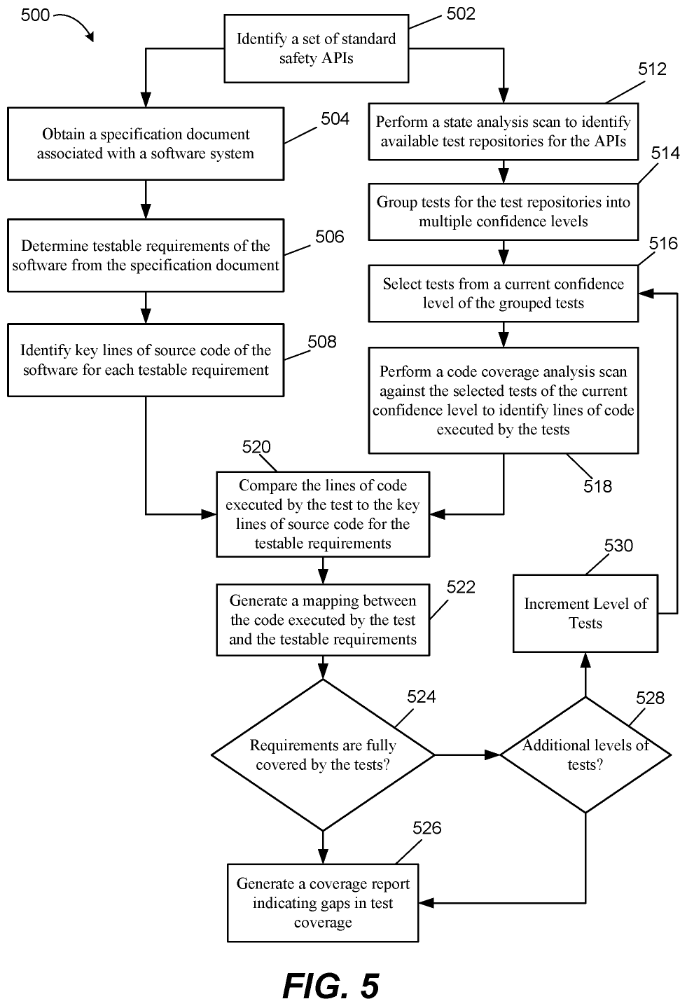

FIG. 5 is a flow diagram of a method 500 of mapping of available software tests to safety related requirements for a specification of a software system, in accordance with one or more aspects of the disclosure. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by safety certification system 140 of at least FIG. 1 and FIG. 3.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

Method 500 begins at block 502, where processing logic identifies a set of standard safety APIs. For example, the processing logic may identify, for an ASIL-B application, a fixed set of APIs. In some examples, one or more levels of ASIL may be identified for an application, such as ASIL-A, ASIL-B, ASIL-C, ASIL-D, or any other ASIL level, which may depend on the context of the application or software system being tested. Additionally, any other safety related API standards may be identified for determining test coverage. At block 504, the processing logic obtains a specification document associated with a software system. For example, the specification document may be a man page of the software system describing various aspects of the software system including requirements of the software system. At block 506, the processing logic determines testable requirements of the software system from the specification document. In some embodiments, testable requirements may be requirements describes in a sufficient manner within the specification document to be identifiable in source code of the software system. At block 508, the processing logic identifies key lines of source code of the software system for each of the testable requirements. In other words, the processing logic identifies lines of source code implementing the testable requirements from the specification document.

Blocks 512-518 may be performed concurrently or sequentially with blocks 504-508. At block 512, the processing logic performs a static analysis scan of one or more repositories to identify available tests for the identified safety APIs. For example, the static analysis scan may identify each test in the one or more repositories that is related to the set of safety APIs identified at block 502. At block 514, the processing logic groups the identified tests from the test repositories into multiple confidence levels. The various confidence levels may indicate a confidence that the test applies to an API. For example, a first confidence level may include tests in which the API appears in the file path and a call to the API appears in the test file. Additional confidence levels may include various levels of indications that the test applies to an API of the set of APIs.

At block 516, the processing logic selects tests from a current confidence level of the grouped tests for code coverage analysis. At block 518, the processing logic performs a code coverage analysis scan against the selected tests of the current confidence level to identify lines of code executed by the tests. For example, the code coverage analysis may include a modified gcovr command to show additional statistics related to lines, branches, decisions, and calls made within the source code during performance of a test.

At block 520, the processing logic compares the lines of code executed by each tests (e.g., the code coverage of the test) to the key lines of source code identified for each of the testable requirements from the specification documents. For example, the gcovr command discussed above may further be modified to include a difference/merge feature to show the granularity of API test coverage and the identified tests (e.g., tests associated with the set of APIs). At block 522, the processing logic generates a mapping between the code executed by each test and the testable requirements.

At block 524, the processing logic determines whether requirements are fully covered by the available tests. At block 526, in response to determining that the requirements are covered, generating a coverage report indicating the mapped tests. At block 528, in response to the requirements not being fully covered, the processing logic determines if there are additional tests from other confidence levels available for mapping of coverage. If there are no additional tests from other confidence levels available, the processing logic proceeds to block 526 to generate a coverage report indicating the mapped tests and any gaps in test coverage. In response to additional tests from other confidence levels being available, the process proceeds to block 530 where the processing logic increments a confidence level of the tests to be analyzed for coverage against the requirements of the specification document and then returns to block 516 for further code coverage analysis. Accordingly, the processing logic updates the mapping and coverage determinations of blocks 516-522.

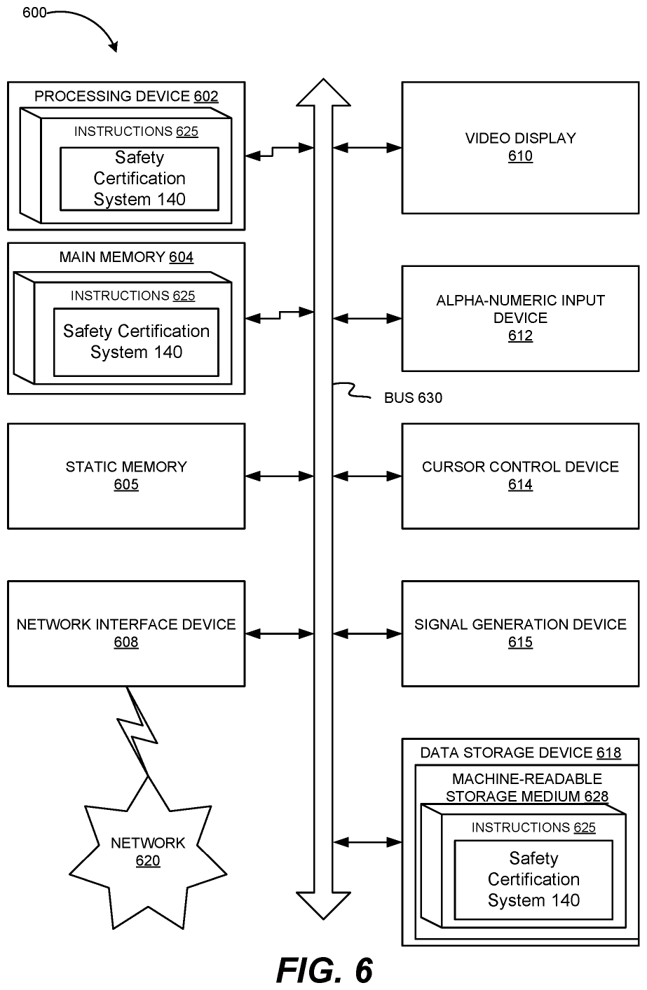

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a safety certification system, e.g., safety certification system 140, for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “identifying,” “determining,” “mapping,” “comparing,” “grouping,” “iterating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
identifying, from a specification document of a software system, requirements of the software system related to vehicle safety functions;
identifying one or more tests for safety related application programming interfaces;
determining, for each of the one or more tests, coverage of source code of the software system; and
mapping, by a processing device, each of the one or more tests to requirements of the software system identified from the specification document in view of the coverage of the source code of the software system for each of the one or more tests.

2. The method of claim 1, wherein mapping the one or more test to requirements of the specification document comprises:
identifying source code corresponding to each requirement of the specification document; and
comparing the source code corresponding to each requirement of the specification document to the coverage of the source code for each of the one or more tests.

3. The method of claim 1, wherein the software system comprises a vehicle integrated software system.

4. The method of claim 1, wherein the safety related APIs comprise automotive safety integrity level (ASIL) APIs associated with vehicle safety standards.

5. The method of claim 1, further comprising:
grouping the one or more tests for safety related APIs into a plurality of confidence levels; and
iterating through the plurality of confidence levels to map the tests in each confidence level to requirements of the specification document.

6. The method of claim 1, further comprising:
identifying requirements of the specification document not covered by the one or more tests; and
providing a recommendation/indication of the requirements not covered.

7. The method of claim 1, wherein determining coverage of the source code from each of the one or more tests comprises executing a code coverage utility for each of the one or more tests identifying code paths of the source code executed during each of the one or more tests.

8. A system comprising:
a memory; and
a processing device, operatively coupled to the memory, to:
identify, from a specification document of a software system, requirements of the software system related to vehicle safety functions;
identify one or more tests for safety related application programming interfaces;
determine, for each of the one or more tests, coverage of source code of the software system; and
map each of the one or more tests to requirements of the software system identified from the specification document in view of the coverage of the source code of the software system for each of the one or more tests.

9. The system of claim 8, wherein to map the one or more test to requirements of the specification document, the processing device is further to:
identify source code corresponding to each requirement of the specification document; and
compare the source code corresponding to each requirement of the specification document to the coverage of the source code for each of the one or more tests.

10. The method of claim 8, wherein the software system comprises a vehicle integrated software system.

11. The system of claim 8, wherein the safety related APIs comprise automotive safety integrity level (ASIL) APIs associated with vehicle safety standards.

12. The system of claim 8, wherein the processing device is further to:
group the one or more tests for safety related APIs into a plurality of confidence levels; and
iterate through the plurality of confidence levels to map the tests in each confidence level to requirements of the specification document.

13. The system of claim 8, wherein the processing device is further to:
identify requirements of the specification document not covered by the one or more tests; and
provide a recommendation/indication of the requirements not covered.

14. The system of claim 8, wherein to determine the coverage of the source code from each of the one or more tests the processing device is to execute a code coverage utility for each of the one or more tests identifying code paths of the source code executed during each of the one or more tests.

15. A non-transitory computer-readable storage medium including instructions that, when executed by a processing device, cause the processing device to:
identify, from a specification document of a software system, requirements of the software system related to vehicle safety functions;
identify one or more tests for safety related application programming interfaces;
determine, for each of the one or more tests, coverage of source code of the software system; and
map, by the processing device, each of the one or more tests to requirements of the software system identified from the specification document in view of the coverage of the source code of the software system for each of the one or more tests.

16. The non-transitory computer-readable storage medium of claim 15, wherein to map the one or more test to requirements of the specification document, the processing device is further to:
identify source code corresponding to each requirement of the specification document; and
compare the source code corresponding to each requirement of the specification document to the coverage of the source code for each of the one or more tests.

17. The non-transitory computer-readable storage medium of claim 15, wherein the software system comprises a vehicle integrated software system.

18. The non-transitory computer-readable storage medium of claim 15, wherein the safety related APIs comprise automotive safety integrity level (ASIL) APIs associated with vehicle safety standards.

19. The non-transitory computer-readable storage medium of claim 15, wherein the processing device is further to:
group the one or more tests for safety related APIs into a plurality of confidence levels; and
iterate through the plurality of confidence levels to map the tests in each confidence level to requirements of the specification document.

20. The non-transitory computer-readable storage medium of claim 15, wherein the processing device is further to:
identify requirements of the specification document not covered by the one or more tests; and
provide a recommendation/indication of the requirements not covered.
